(19) United States
(12) Patent Application Publication
(10) Pub. No.: US 2019/0257578 A1
(43) Pub. Date: Aug. 22, 2019

(54) MAINTAINING A TEMPERATURE OF A BEVERAGE

(71) Applicant: Zachary Miller, Bay City, MI (US)

(72) Inventor: Zachary Miller, Bay City, MI (US)

(21) Appl. No.: 16/281,709

(22) Filed: Feb. 21, 2019

Related U.S. Application Data
(60) Provisional application No. 62/633,596, filed on Feb. 21, 2018.

(51) Int. Cl. F25D 31/00; A47J 47/14

(52) U.S. Cl. CPC F25D 31/007; A47J 47/14

(57) ABSTRACT

Devices can be configured to substantially maintain the serving temperature of a beverage, such as individual beers in a beer flight. In one or more arrangements, a device can include a housing portion and an insert portion. The insert portion can be selectively received in a passage in the housing portion. The insert portion can include an insert body, a cover, and a cold pack. The cover can be attached to the insert body. The cold pack can be received in a space substantially enclosed by the insert body and the cover. A portion of the cover can be exposed to an exterior of the device. When a drinking vessel is directly supported on an exposed portion of the cover, the cold pack can draw thermal energy from a beverage in the drinking vessel across the cover. In some cases, the device can be configured as a beer flight paddle.

### CROSS-REFERENCE TO RELATED APPLICATIONS

This application claims the benefit of U.S. Provisional Application No. 62/633,596, filed on Feb. 21, 2018, which is incorporated herein by reference in its entirety.

### FIELD

The subject matter described herein relates in general to beverages and, more particularly, to maintaining a temperature of a beverage.

### BACKGROUND

Beer is a widely consumed alcoholic beverage around the world. There are numerous styles and brands of beer available, and new beers are being introduced every year. One way that a person can sample a variety of beers is by ordering a beer flight. A beer flight typically includes several small beer glasses with each glass containing a different beer. A beer flight allows a person to try multiple styles/brands of beer in one sitting and in moderate quantities.

Beer flights are sometimes served on a beer flight paddle. The beer flight paddle includes a series of openings. Each opening is designed to receive a small glass of beer.

### SUMMARY

In one respect, the subject matter described herein is directed to a device for maintaining a temperature of a beverage. The device including a housing portion and an insert portion. The housing portion including a main body. A passage can be defined in the main body. The passage can open to a side of the main body. The insert portion can be received in the passage. The insert portion can be selectively inserted into and removed from the passage. The insert portion can include an insert body, a cover, and a cold pack. The cover can be attached to the insert body. A space can be substantially enclosed by the insert body and the cover. The cold pack can be received in the space. The cold pack can be configured for configured for repeat freezing. A portion of the cover can be exposed to an exterior of the device when the insert portion is received in the passage. Thus, a temperature of a beverage in a drinking vessel directly supported on an exposed portion of the cover can be substantially maintained.

In another respect, the subject matter described herein is directed to a beer flight paddle. The beer flight paddle can include a housing portion and an insert portion. The housing portion can include a main body. A passage can be defined in the main body. The passage can open to a side of the main body. One or more apertures can be defined by the main body. The insert portion can be received in the passage. The insert portion can be selectively inserted into and removed from the passage. The insert portion can include an insert body, a cover, and a cold pack. The cover can be attached to the insert body. A space can be substantially enclosed by the insert body and the cover. The cold pack can be received in the space. The cold pack can be configured for configured for repeat freezing. A two or more recesses can be defined by portion of the cover and apertures in the main body. The portions of the cover that define the recesses can be exposed to an exterior of the beer flight paddle when the insert portion is received in the passage. Thus, a drinking vessel can be directly supported on an exposed portion of the cover, and a temperature of a beverage in the drinking vessel can be substantially maintained.

### BRIEF DESCRIPTION OF THE DRAWINGS

FIG. 1 is a view of an example of a beer flight paddle.

FIG. 2 is a view of an upper side the beer flight paddle.

FIG. 3 is a view of a lower side of the beer flight paddle.

FIG. 4 is a view of a lateral side of the beer flight paddle.

FIG. 5 is a view of a first longitudinal end of the beer flight paddle, showing a retention element in a closed position.

FIG. 6 is a view of the first longitudinal end of the beer flight paddle, showing the retention element in an open position.

FIG. 7 is a view of a second longitudinal end of the beer flight paddle.

FIG. 8 is an exploded view of the beer flight paddle.

FIGS. 9A-9C are cross-sectional views, viewed along line 9-9 in FIG. 2, showing various examples of interlocking engagement between an insert portion and a housing portion of the beer flight paddle.

FIG. 10 is a view of an example of a housing portion of the beer flight paddle.

FIG. 11 is a view of an upper side of the housing portion.

FIG. 12 is a view of a lower side of the housing portion.

FIG. 13 is a view of a first longitudinal end of the housing portion.

FIG. 14 is a view of an example of an insert portion of the beer flight paddle.

FIG. 15 is a view of an upper side of the insert portion.

FIG. 16 is a view of a lower side of the insert portion.

FIG. 17 is a view of a lateral side of the insert portion.

FIG. 18 is a view of a first longitudinal end of the insert portion.

FIG. 19 is a view of a second longitudinal end of the insert portion.

### DETAILED DESCRIPTION

While a beer flight is being consumed by a person, the temperature of the individual beers in the flight may increase over time due to, at least in part, exposure to the ambient air. In some instances, by the time the user reaches the last glass or glasses in the flight, the temperature of the beer may be less than optimal and may detract from the user's enjoyment of the beer. This detailed description relates to substantially maintaining the serving temperature of individual beers in a beer flight. In one or more arrangements, a beer serving paddle can be configured to substantially maintain the temperature of individual beers in a beer flight.

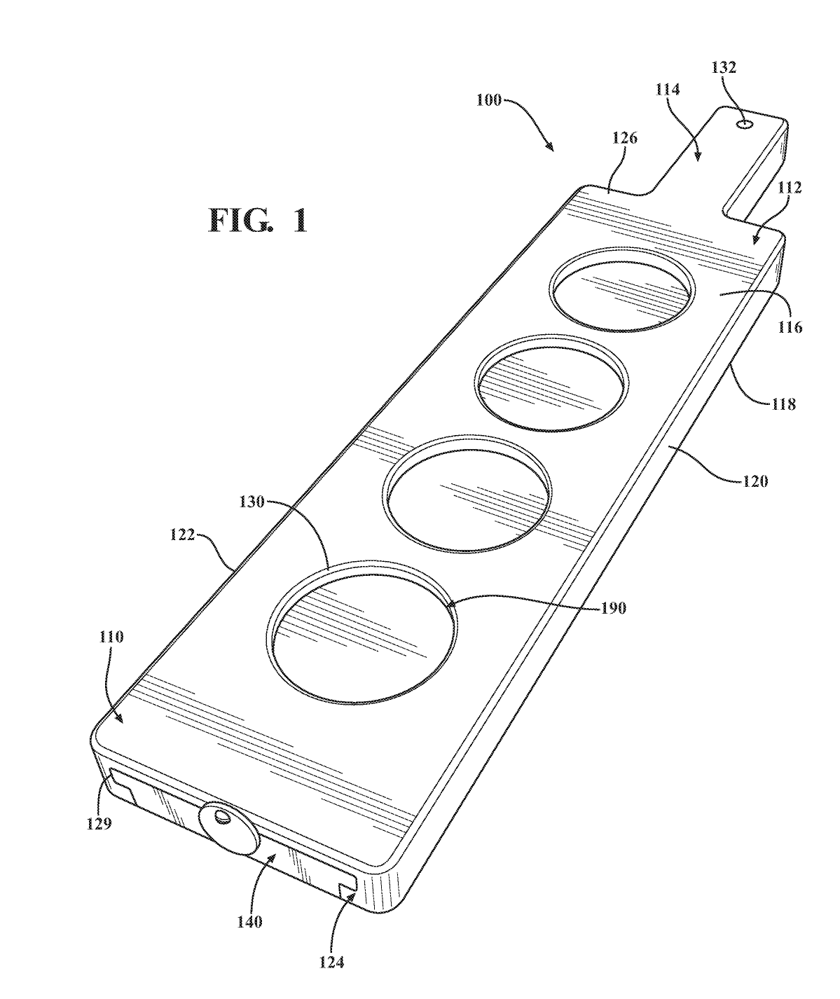

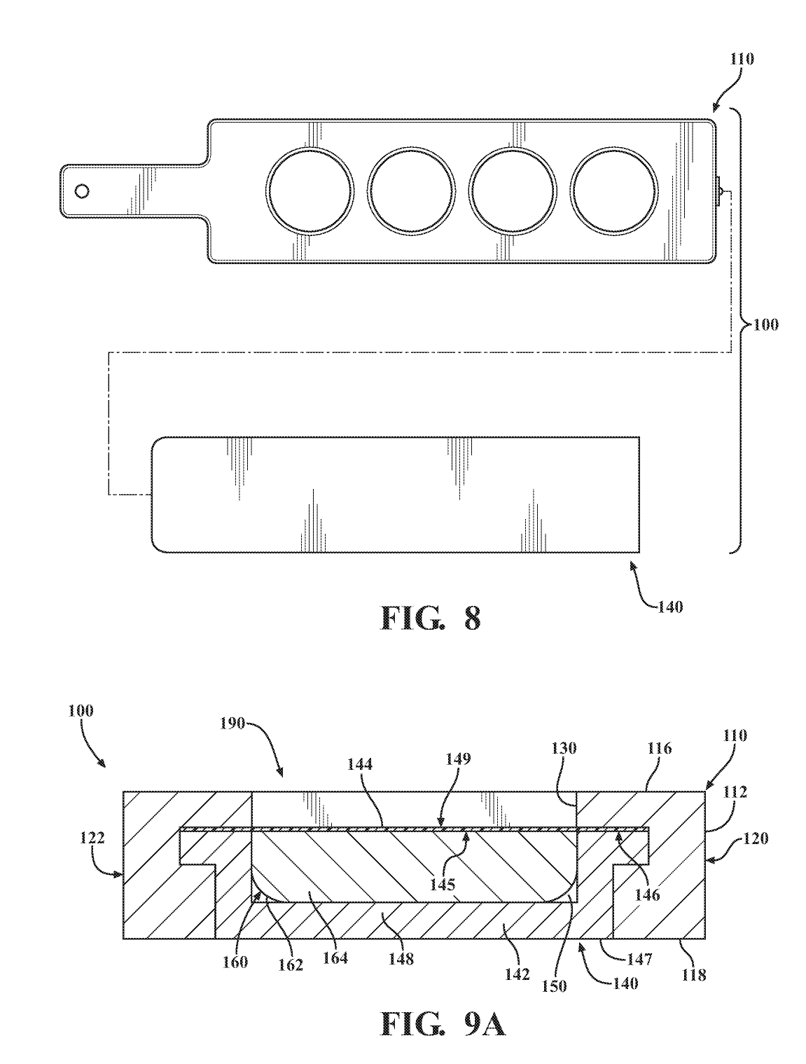

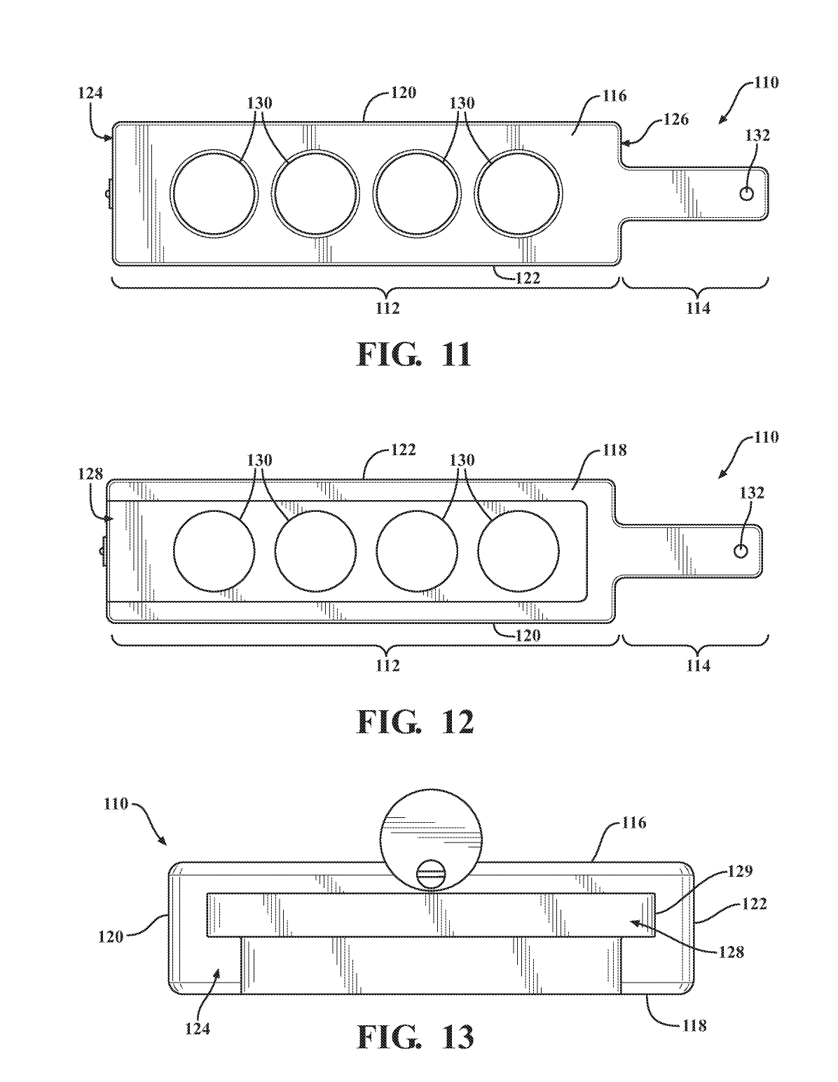

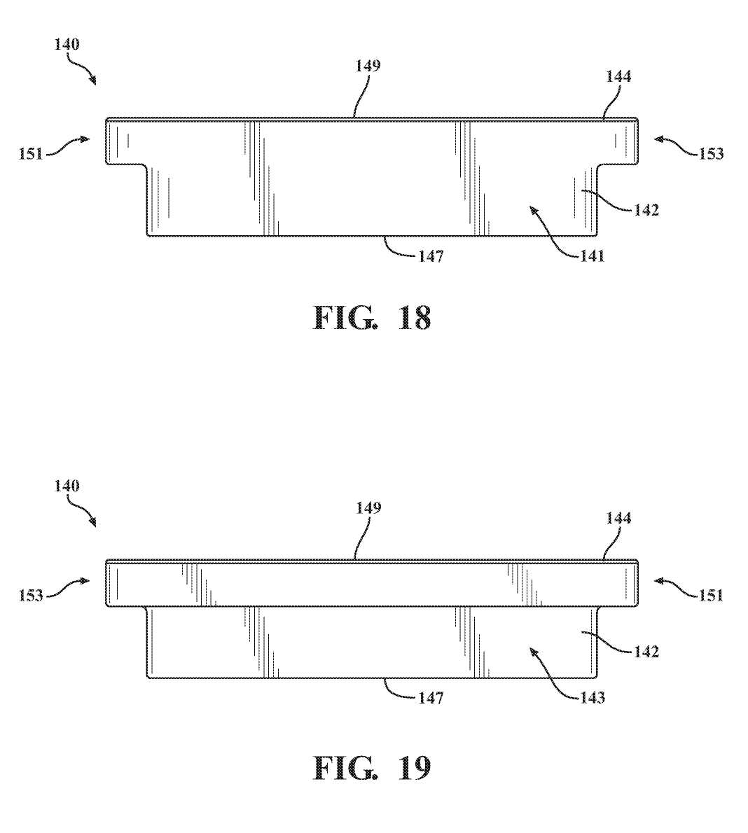

Detailed embodiments are disclosed herein; however, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-19, but the embodiments are not limited to the illustrated structure or application.

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details.

Arrangements described herein are directed to apparatus or devices for substantially maintaining the serving temperature of beer. FIGS. 1-19 show one example of such a device. In particular, the device is configured as a beer flight paddle 100. In one or more arrangements, the beer flight paddle 100 can include a housing portion 110 and an insert portion 140, each of which will be described in turn below.

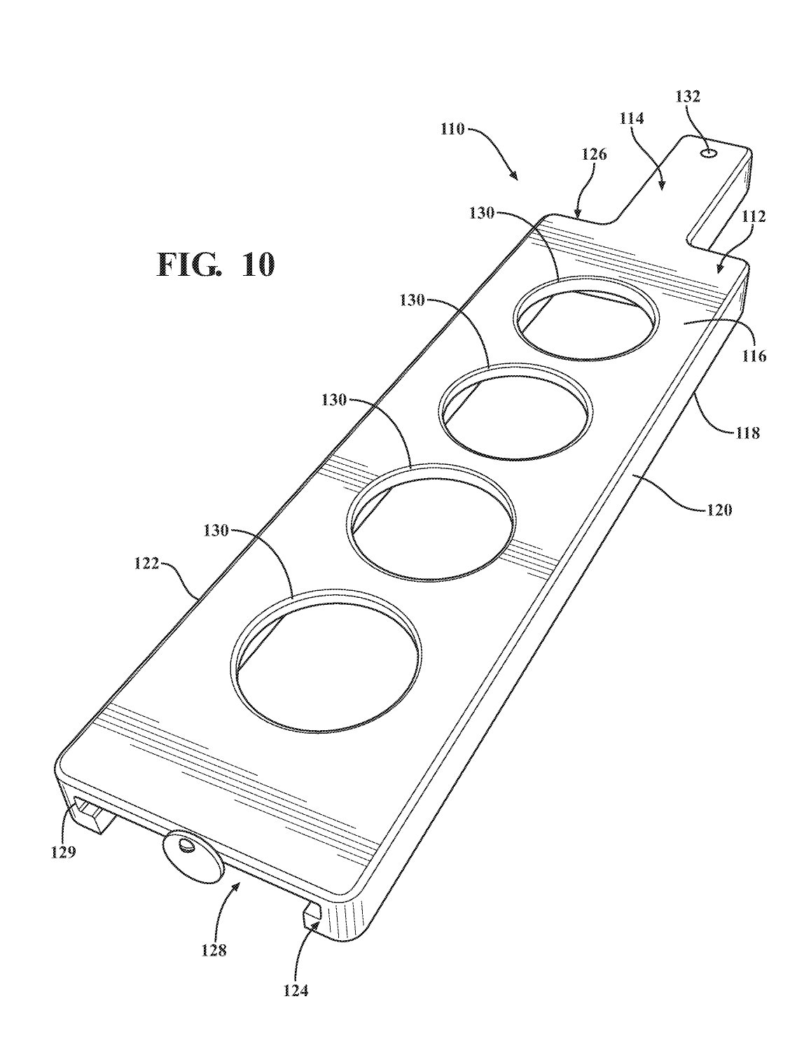

Referring to FIGS. 10-13, an example of the housing portion 110 is shown. The housing portion 110 can include a main body 112 and a handle 114. The main body 112 can include an upper side 116 and a lower side 118. The terms “upper” and “lower” are used to designate the relative positions of these sides when the beer flight paddle 100 is used in its intended operational position. The main body 112 can include a first lateral side 120 and a second lateral side 122. The main body 112 can include a first longitudinal end 124 and a second longitudinal end 126. The main body 112 can be made as a single unitary structure, or it can be formed by a plurality of separate elements that are joined together in any suitable manner.

The housing portion 110 can be configured to receive the insert portion 140. To that end, the housing portion 110 can include a passage 128 into which the insert portion 140 can be received. The passage 128 can have various configurations. The passage 128 can extend a distance along the length of the main body 112. In one or more arrangements, the passage 128 can extend a majority of the length of the main body 112. In one or more arrangements, the passage 128 can extend nearly the entire length of the main body 112. In one or more arrangements, the passage 128 can open to the first longitudinal end 124 of the main body 112. As a result, an opening 129 can be formed in the first longitudinal end 124. In one or more arrangements, the passage 128 can be closed to the first lateral side 120 and/or to the second lateral side 122 of the main body 112. In one or more arrangements, the passage 128 can be closed to the second longitudinal end 126 of the main body 112.

One or more apertures 130 can be defined in the housing portion 110. For example, one or more apertures 130 can be defined in the upper side 116 of the housing portion 110. The apertures 130 can have any suitable size, shape, configuration, and/or arrangement. There can be any quantity of apertures 130. In one or more arrangements, the apertures 130 can be substantially identical to each other. In one or more arrangements, one or more of the apertures 130 can be different from the other apertures 130 in one or more respects, including in any respect described herein.

The apertures 130 can have any suitable shape. In one or more arrangements, the apertures 130 can be substantially circular as shown. As used herein, the term “substantially” includes exactly the term it modifies and slight variations therefrom (e.g., within normal manufacturing tolerances, within about 10 percent (or degrees or other units) or less, within about 5 percent or less, within about 4 percent s or less, within about 3 percent or less, within about 2 percent or less, or within about 1 percent or less). In other arrangements, the apertures 130 can be substantially oval, substantially triangular, substantially rectangular, substantially square, or substantially polygonal, just to name a few possibilities.

The apertures 130 can be distributed in any suitable manner on the housing portion 110. In one or more arrangements, the apertures 130 can be substantially aligned in a row, as is shown in FIGS. 10-12. In one or more arrangements, there can be more than one row of apertures 130. In some arrangements, the rows of apertures 130 can be substantially parallel to each other. In some arrangements, the apertures 130 can be arranged in a shape or a pattern.

There can be any suitable quantity of apertures 130. FIGS. 10-12 show an example in which there are four apertures 130. However, it will be appreciated that there can be more than four apertures 130 or less than four apertures 130. In one or more arrangements the housing portion 110 can have between two and eight apertures 130.

The handle 114 can have any suitable configuration. In one or more arrangements, the handle 114 can have any suitable cross sectional shape. For instance, the handle 114 can be substantially rectangular (see FIG. 7), substantially square, substantially circular, substantially oval, or substantially polygonal in cross-sectional shape.

In one or more arrangements, the handle 114 can include one or more ergonomic features to facilitate engagement by a user. For instance, at least a portion of the handle 114 can include a flexible, soft, and/or gel material, such as a cover or wrap, around at least a portion of the handle 114. In one or more arrangements, the handle 114 can include one or more grips, textures, and/or surface treatments. The handle 114 can extend in a straight or linear manner, as is shown. Alternatively, the handle 114 can include one or more non-linear features (e.g., curves, bends, steps, etc.).

In one or more arrangements, the handle 114 can extend from the second longitudinal end 126 of the main body 112. However, it will be appreciated that the handle 114 can extend from other portions of the main body 112. In some arrangements, the housing portion 110 may not have a handle 114.

In one or more arrangements, the housing portion 110 can include one or more features to facilitate storage of the housing portion 110 and/or the beer flight paddle 100 when not in use. For instance, the handle 114 can include an aperture 132. A rope, cord, or other element can be received in the aperture 132 and tied together to form a loop. Alternatively, the housing portion 110 can include a hook. In such case, the housing portion 110 can be hung by the hook on another structure when not in use.

The housing portion 110 can be made of any suitable material. For instance, the housing portion 110 can be made of wood, plastic, and/or metal, just to name a few possibilities. In one more arrangements, the handle 114 can be made of the same material as the main body 112. In one or more arrangements, the handle 114 and the main body 112 can be a unitary structure. Alternatively, the handle 114 and the main body 112 can be separate structures that are subsequently joined in any suitable manner.

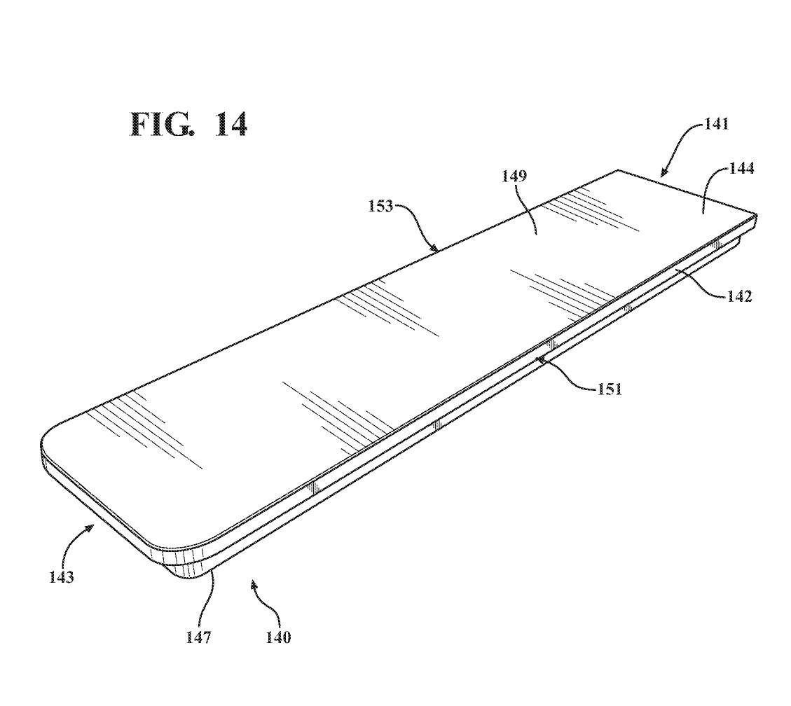

Referring to FIGS. 14-19, an example of the insert portion 140 is shown. The insert portion 140 can include a first longitudinal end 141 and a second longitudinal end 143. The insert portion 140 can include a first lateral side 151 and a second lateral side 153. The insert portion 140 can include an upper side 149 and a lower side 147. The terms “upper” and “lower” are used to designate the relative positions of these sides when the beer flight paddle 100 is used in its intended operational position.

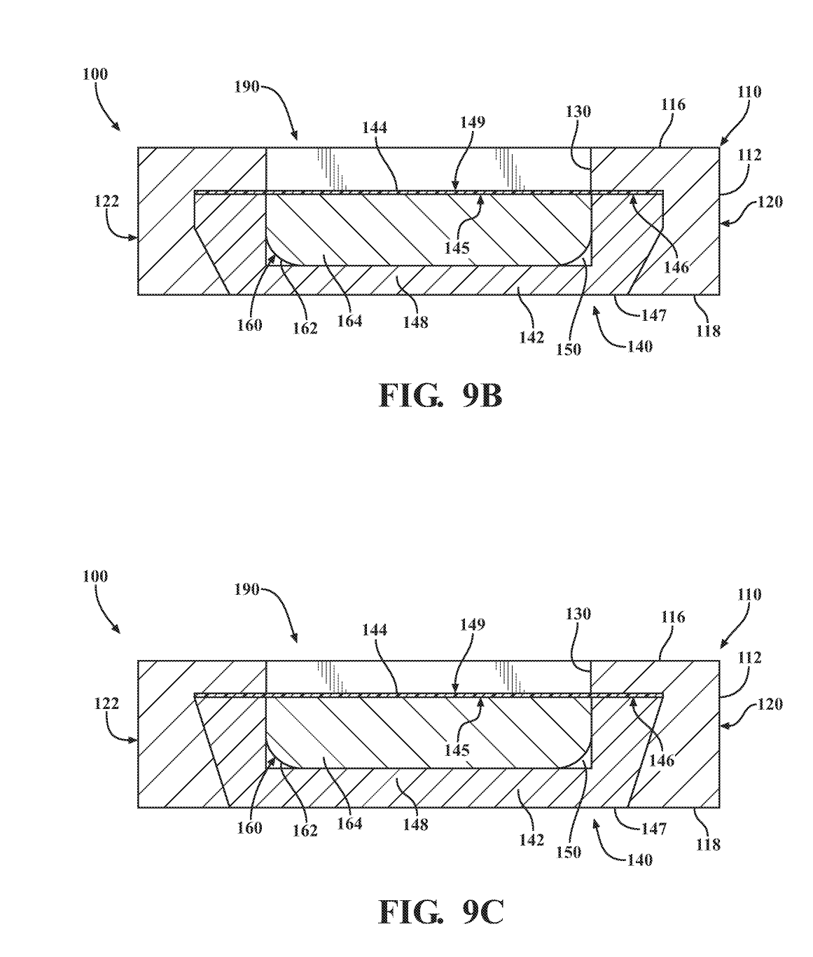

In one or more arrangements, the insert portion 140 can include an insert body 142 and a cover 144. The cover 144 can be attached to an upper side 146 of the insert body 142 to enclose a space 150 between them (see FIGS. 9A-9C). The cover 144 can be attached to the insert body 142 in any suitable manner, such as by adhesive(s), bonding, welding, brazing, fastener(s), and/or mechanical engagement(s), just to name a few possibilities. In one or more arrangements, the cover 144 can be attached to the insert body 142 such that the cover 144 is not readily separable from the insert body 42. “Not readily separable” means that the cover and the insert body are attached such that they can only be separated by using tools and/or by destroying or damaging the cover and/or the insert body. However, in some arrangements, the cover 144 and the insert body 142 may be attached in a way that allows them to be readily separable, such as by hand, without tools, and/or without destroying or damaging the cover and/or the insert body.

The insert body 142 can be made of any suitable material. In one or more arrangements, the insert body 142 can be made of wood, metal, and/or plastic. In one or more arrangements, the insert body 142 can be made of the same material as the housing portion 110.

The cover 144 can be made of any suitable material. The cover 144 can be made of a material that can facilitate heat transfer across it. In the way of examples, the cover 144 can be made ceramic, plastic, and/or metal. For instance, the cover 144 can be made of copper or aluminum. In one or more arrangements, the cover 144 can be made of a different material than the insert body 142.

Referring to FIGS. 9A-9C, a cold pack 160 can be received in the space 150. The cold pack 160 can configured for repeat freezing. In one or more arrangements, the cold pack 160 can include an outer casing 162 containing a freezable material 164. The outer casing 162 can be made of any suitable material. In one or more arrangements, the outer casing 162 can be made of Mylar.

The freezable material 164 can be any suitable material. In one or more arrangements, the freezable material 164 can have a freezing point that is less than the freezing temperature of water (32 degrees Fahrenheit). More particularly, the freezable material 164 can have a freezing point of substantially 20 degrees Fahrenheit or less. Still more particularly, the freezable material 164 can have a freezing point of substantially 18 degrees Fahrenheit. In one or more arrangements, the freezable material 164 can include water. In one or more arrangements, the freezable material 164 can include a salt base, polymer beads, and/or water absorbing particles. These materials can be used in combination with water to form the freezable material 164. For instance, salt can be dissolved in the water. As another example, the freezable material 164 can be mixture of water and polymer beads and/or water absorbing particles.

In one or more arrangements, the insert portion 140 can be configured to ensure contact between the cold pack 160 and the cover 144. As an example, the cold pack 160 can be attached to an inner side 145 of the cover 144. Such attachment can be achieved in any suitable manner, including by adhesive(s), fastener(s), and/or mechanical engagement(s). As an alternative or in addition, a biasing element can be operatively positioned in the space 150 between the cold pack 160 and a bottom wall 148 of the insert body 142. In some instances, the biasing element can be attached to the bottom wall 148 of the insert body 142 and/or to the cold pack 160, such as by adhesive(s) and/or fastener(s). In one or more arrangements, the biasing element can be a piece of material, such as, for example, open cell foam, polyurethane, or a synthetic rubber. When the piece of material is frozen, it can contract. However, as the piece of material warms up, it can expand to keep the cold pack 160 in contact with the inner side 145 of the cover 144. In one or more arrangements, the biasing element can be any suitable type of spring.

The insert portion 140 can be received in and/or engage the housing portion 110 in any suitable manner. For instance, the insert portion 140 and the housing portion 110 can be configured for interlocking engagement. As a result of such interlocking engagement, the insert portion 140 can be retained in the housing portion 110 in one or more directions. Various examples of such interlocking engagement are shown in FIGS. 9A-9C. As a result of such arrangements, the insert portion 140 can be prevented from falling out through the open lower side 118 of the housing portion 110. The housing portion 110 can be configured to physically constrain the insert portion 140 in one or more other directions, such as in the upward direction (e.g., by the upper side 116), one or more lateral directions (i.e., in the direction of the first lateral side 120 and/or the second lateral side 122), and/or as well as in the longitudinal direction in the direction of the second longitudinal end 126. The insert portion 140 can be selectively inserted into and/or removed from the housing portion 110.

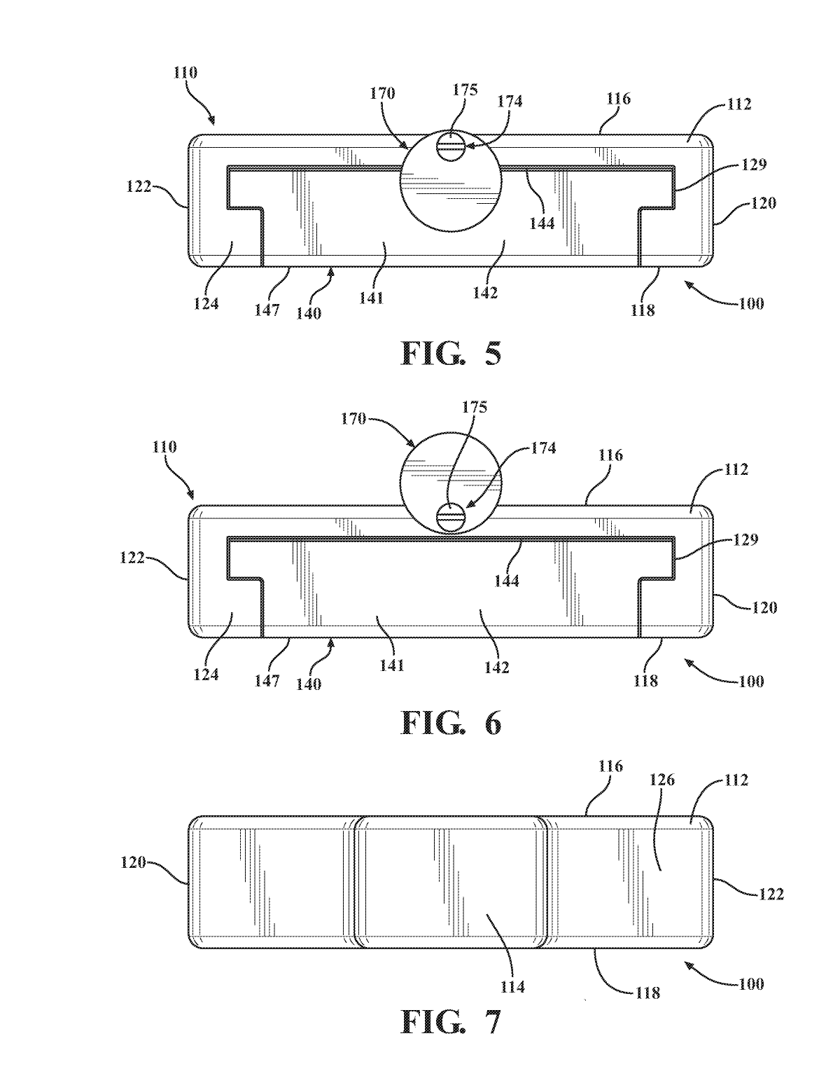

The beer flight paddle 100 can be configured to minimize the possibility of the insert portion 140 unintentionally sliding out of the passage 128 and through the opening 129 in the first longitudinal end 124 of the housing portion 110. Such a configuration can be achieved in any suitable manner. For instance, referring to FIGS. 5 and 6, the beer flight paddle 100 can include a retention element 170. In one or more arrangements, the retention element 170 can be a piece of material. The retention element 170 can have any suitable size, shape, and/or configuration. In one or more arrangements, the retention element 170 can have a substantially circular shape. However, it will be appreciated that the retention element 170 can have other shapes.

The retention element 170 can be movable between a closed position (FIG. 5) and an open position (FIG. 6). In the closed position, the retention element 170 can cover at least a portion of the opening 129 in the first longitudinal end 124 of the housing portion 110. When the retention element 170 is in the closed position, the insert portion 140 can be prevented from sliding out through the opening 129 in the first longitudinal end 124 of the housing portion 110. In the open position, the retention element 170 does not cover the opening 129 in the first longitudinal end 124 of the housing portion 110. When the retention element 170 is in the open position, the insert portion 140 can be slid out through the opening 129 in the first longitudinal end 124 of the housing portion 110.

The retention element 170 can be can be movable between the closed position and the open position in any suitable manner. As an example, the retention element 170 can be rotatably attached to the first longitudinal end 124 of the housing portion 110. As an example, the retention element 170 can include an aperture. The aperture can be offset from the center of the retention element 170. A pin 174 can be received in the aperture and can be attached to the housing portion 110 in any suitable manner. The clearance between the aperture and the pin 174 can be such that the retention element 170 can be rotatable about the pin 174 (e.g., such as by manual manipulation). The pin 174 can include a head 175 to retain the retention element 170 thereon.

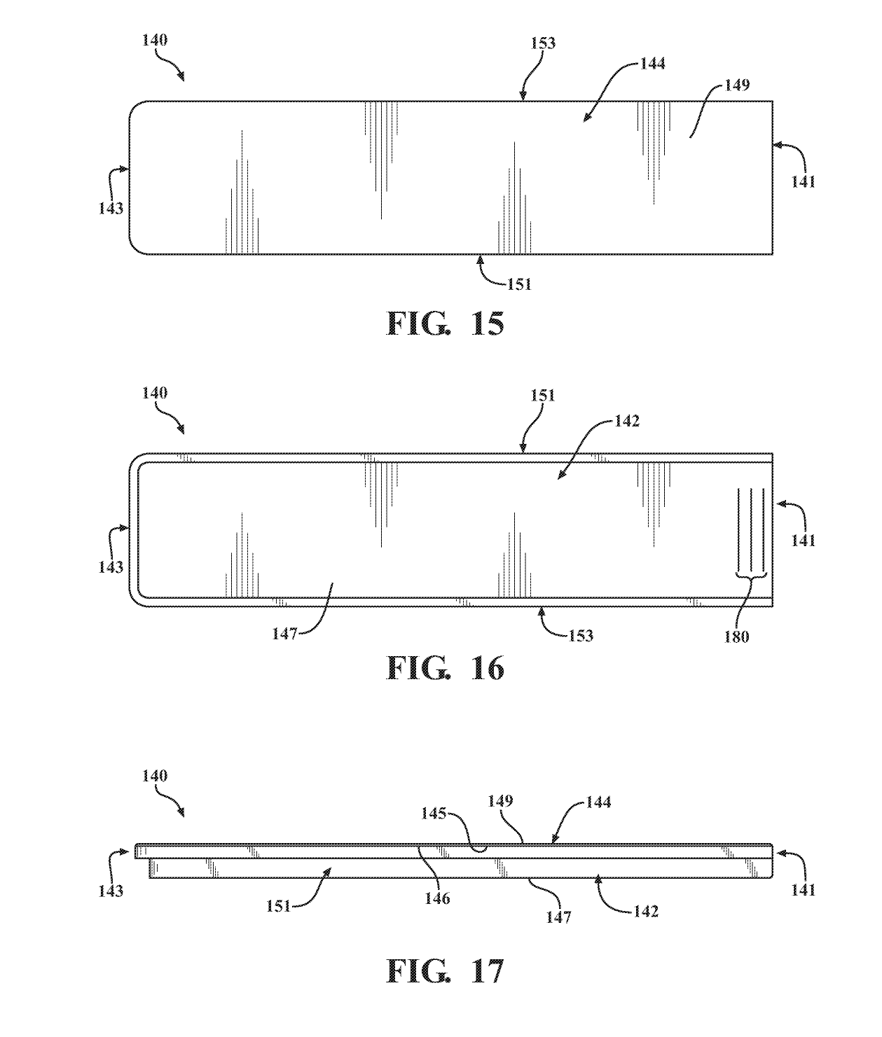

In some arrangements, the housing portion 110 and/or the insert portion 140 can be configured so that the insert portion 140 can be received in the housing portion 110 in only one way. For example, a first longitudinal end 141 of the insert portion 140 can be different from a second longitudinal end 143 of the insert portion 140, as is shown in FIGS. 15-19. As an example, the first longitudinal end 141 can be substantially flat, the second longitudinal end 143 can be stepped, as is shown in FIG. 17. In such case, if the insert portion 140 is inserted into the opening 129 of the passage 128 via the first longitudinal end 141, then the insert portion 140 cannot be fully received within the passage 128 and will protrude beyond the first longitudinal end 124 of the housing portion 110. However, if the insert portion 140 is inserted into the opening 129 of the passage 128 via the second longitudinal end 143, then the insert portion 140 can be received entirely within the passage 128. In such case, the insert portion 140 will not protrude beyond the first longitudinal end 124 of the housing portion 110. The first longitudinal end 141 of the insert portion 140 can be substantially flush with the first longitudinal end 124 of the housing portion 110. As another example, the width of the insert portion 140 can taper from the first longitudinal end 141 to the second longitudinal end 143. The width of the passage 128 can also taper along its length from the opening 129 to its end. As a result of such arrangements, the insert portion 140 can only be received in the passage 128 in one direction.

In some arrangements, the beer flight paddle 100 can be configured to facilitate a user's separation of the insert portion 140 and the housing portion 110. As an example, the housing portion 110 and/or the insert portion 140 can include one or more surface treatments or features to facilitate engagement therewith. In one or more arrangement, a lower side 147 of the insert portion 140 can include grooves 180 (see e.g., FIGS. 3 and 16), knurling, recesses, and/or notches to facilitate engagement by a user's a finger or fingernail. The lower side 147 can be exposed when the insert portion 140 is received in the housing portion 110.

The beer flight paddle 100 can include one or more recesses 190. The one or more recesses 190 can be defined by the apertures 130 in the housing portion 110 and the upper side 149 of the insert portion 140. The one or more recesses 190 can have any suitable depth. In one or more arrangements, the one or more recesses 190 can have a depth of substantially 0.25 inches. The one or more recesses 190 can be configured to receive a drinking glass.

Now that the individual components of the beer flight paddle 100 have been described, one manner of using the beer flight paddle 100 will now be presented. This description may be applicable to the embodiments described above in relation to FIGS. 1-19, but it is understood that the method can be carried out with other suitable systems and arrangements. Moreover, the following description may include other steps that are not described here, and in fact, the description is not limited to including every step described herein, nor is it limited to the described chronological order. Indeed, some of the steps may be performed in a different order than what is shown and/or at least some of the steps shown can occur simultaneously.

For purposes of this description, the beer flight paddle 100 can begin in a disassembled condition in which the insert portion 140 and the housing portion 110 are separated from each other. The insert portion 140 can located be inside of a freezer or other cooling chamber or container. As a result, the cold pack 160 can be frozen. When a flight of beer is to be served, the insert portion 140 can be retrieved from the freezer.

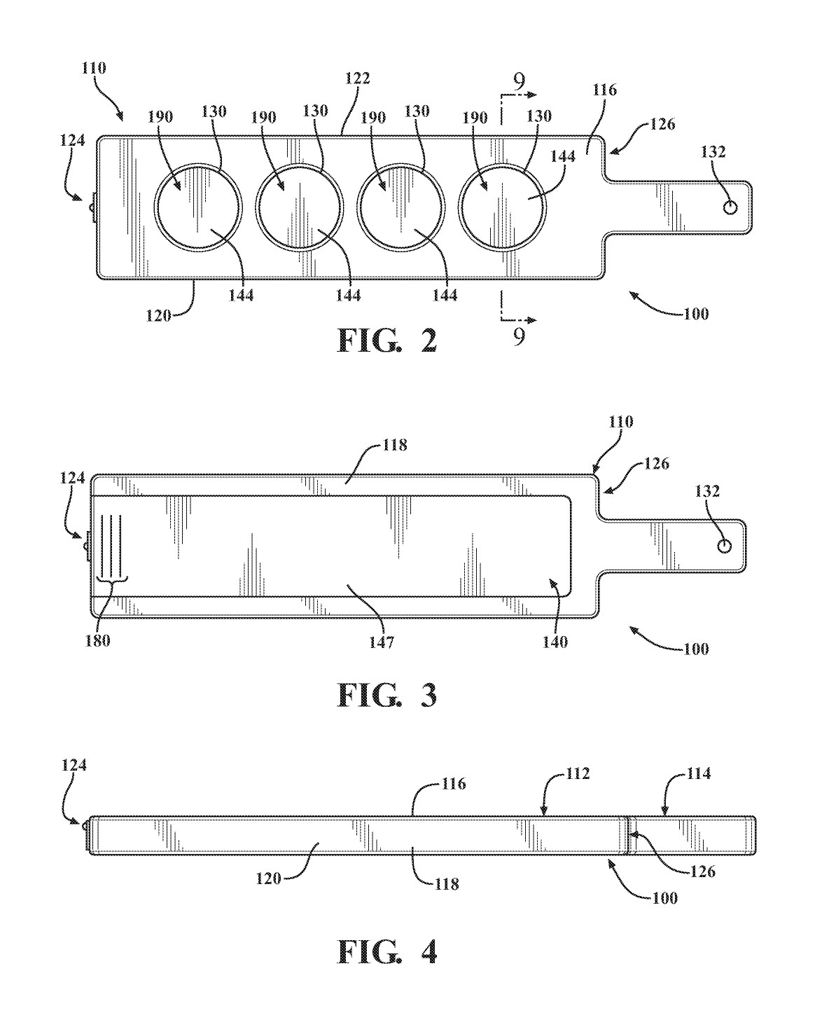

The insert portion 140 and the housing portion 110 can be brought together so that the insert portion 140 is received in the passage 128 of the housing portion 110 to form the beer flight paddle 100. “Brought together” or “bringing together” means that the insert portion, the housing portion, or both are manipulated. When the insert portion 140 is properly installed, the lower side 147 of the insert portion 140 can be substantially flush with the lower side 118 of the housing portion 110, as is shown in FIGS. 4-6. Also, the first longitudinal end 124 of the housing portion can be substantially flush with the first longitudinal end 141 of the insert portion 140, as is shown in FIGS. 2-4.

Individual flight glasses can be filled with a selected beer and placed on the beer flight paddle 100. Each glass can be received in a respective one of the recesses 190. The bottom of each flight glass can be directly supported on the cover 144 of the insert portion 140. More particularly, the bottom of each flight glass can directly contact the upper side 149 of the insert portion 140. The flight of beer can be transported using the beer flight paddle 100 and served to a consumer on the beer flight paddle 100.

The consumer can enjoy the individual beers in the flight. Over time, the ambient air can have a warming effect on the individual beers in the flight. However, according to arrangements described herein, the cold pack 160 can draw thermal energy from the beer in the flight glasses across the cover 144. It will be appreciated that such heat exchange occurs only across the bottom of the flight glasses. The heat exchange can counteract the warming effect on the beer from the ambient air. In this way, the temperature of the individual beers in the flight can be substantially maintained at the temperature at which they were served. Thus, by the time the consumer reaches the last glass or glasses in the flight, the temperature of the beer will be substantially the same as when it was served.

While arrangements described herein are described in connection with beer paddles, it will be understood that arrangements described herein are not limited to beer paddles. Indeed, arrangements described herein can be used in connection with other devices used to serve beverages or upon which beverages can be supported. For instance, arrangements described herein can be used in connection with coasters, serving trays, serving crates, and/or serving boards, just to name a few possibilities. Still further, while arrangements are described herein in connection with beer, it will be appreciated that these arrangements are not limited in this respect. Arrangements described herein can be used in connection with other beverages.

The housing portion 110 of the beer flight paddle 100 can include design elements, brands, logos, content, information, etc. thereon. As an example, a brewery may wish to have its name and/or logo appear in one or more locations on the beer flight paddle 100. Such items can be provided in any suitable manner, such as by etching, carving, wood burning, painting, stamping, and/or stickers, just to name a few possibilities.

It will be appreciated that arrangements described herein can provide numerous benefits, including one or more of the benefits mentioned herein. For example, arrangements described herein can substantially maintain beers at the temperature at which they were initially severed. Arrangements described herein can enable a portion (e.g., the insert portion 140) of a beer flight paddle 100 to be frozen, thereby facilitating more efficient cooling and/or usage of freezer space. Arrangements described herein can result in the cover 144 of the insert portion 140 to frost over, giving the beer flight paddle 100 an attractive and/or interesting appearance. Arrangements described herein can help to substantially maintain the temperature of a beverage from the bottom of the glass only.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g. AB, AC, BC or ABC).

Aspects herein can be embodied in other forms and/or combinations without departing from the spirit or essential attributes thereof. Thus, it will of course be understood that embodiments are not limited to the specific details described herein, which are given by way of example only, and that various modifications and alternations are possible within the scope of this specification.

What is claimed is:

1. A device for maintaining a temperature of a beverage, the device comprising:
a housing portion, the housing portion including a main body, a passage being defined in the main body, the passage opening to a side of the main body; and
an insert portion, the insert portion being received in the passage, the insert portion being selectively insertable into and removable from the passage, the insert portion including:
an insert body;
a cover attached to the insert body, a space being substantially enclosed by the insert body and the cover; and
a cold pack received in the space, the cold pack being configured for configured for repeat freezing,
a portion of the cover being exposed to an exterior of the device when the insert portion is received in the passage, whereby a temperature of a beverage in a drinking vessel directly supported on an exposed portion of the cover is substantially maintained.

2. The device of claim 1, wherein the cold pack includes an outer casing containing a freezable material.

3. The device of claim 2, wherein the freezable material has freezing point of less than 32 degrees Fahrenheit.

4. The device of claim 2, wherein the freezable material has freezing point of substantially 20 degrees Fahrenheit or less.

5. The device of claim 2, wherein the freezable material includes at least one of a salt base, polymer beads, or water absorbing particles.

6. The device of claim 1, wherein the cover is made of copper or aluminum.

7. The device of claim 1, further including one or more recesses, wherein one or more recesses are defined by one or more portions of the cover and one or more apertures in the main body, and wherein the one or more recesses are configured to receive a drinking vessel.

8. The device of claim 1, wherein the insert portion is configured to maintain contact between the cold pack and the cover.

9. The device of claim 1, wherein the housing portion further includes a handle, and wherein the handle extends away from the main body.

10. The device of claim 1, wherein the device further including a retention element operatively connected to the main body, and wherein the retention element is configured to prevent the insert portion from sliding out of the passage and through the opening in the main body.

11. The device of claim 1, wherein the insert portion and the passage are configured for interlocking engagement.

12. A beer flight paddle, comprising:
a housing portion, the housing portion including a main body, a passage being defined in the main body, the passage opening to a side of the main body, one or more apertures being defined by the main body; and
an insert portion, the insert portion being received in the passage, the insert portion being selectively insertable into and removable from the passage, the insert portion including:
an insert body;
a cover attached to the insert body, a space being substantially enclosed by the insert body and the cover; and
a cold pack received in the space, the cold pack being configured for configured for repeat freezing,
a plurality of recesses defined by portions of the cover and a plurality of apertures defined in the main body, portions of the cover defining the recesses being exposed to an exterior of the beer flight paddle when the insert portion is received in the passage, whereby a temperature of a beverage in a drinking vessel directly supported on an exposed portion of the cover is substantially maintained.

13. The beer flight paddle of claim 12, wherein the cold pack includes an outer casing containing a freezable material.

14. The beer flight paddle of claim 13, wherein the freezable material has freezing point of substantially 20 degrees Fahrenheit or less.

15. The beer flight paddle of claim 13, wherein the freezable material includes at least one of a salt base, polymer beads, or water absorbing particles.

16. The beer flight paddle of claim 12, wherein the cover is made of copper or aluminum.

17. The beer flight paddle of claim 12, wherein the cover is not readily separable from the insert body.

18. The beer flight paddle of claim 12, wherein the cover is made of a material configured to facilitate heat transfer across the cover.

19. The beer flight paddle of claim 18, wherein the cover is made of copper or aluminum.

20. The beer flight paddle of claim 12, wherein the housing portion further includes a handle, and wherein the handle extends away from the main body.
